(19) United States
(12) Patent Application Publication
(10) Pub. No.: US 2011/0131482 A1
(43) Pub. Date: Jun. 2, 2011

(54) SYSTEM AND METHOD FOR MULTI-CHANNEL PUBLISHING

(75) Inventors: Emil Shteinvil, Kfar-Saba (IL); Yonatan P. Stern, Sde Warburg (IL); Peter Lifshits, Kedumim (IL); Sergei Steinvil, Kfar-Saba (IL)

(73) Assignee: Olive Software Inc., Aurora, CO (US)

(21) Appl. No.: 12/913,786

(22) Filed: Oct. 28, 2010

Related U.S. Application Data
(60) Provisional application No. 61/361,453, filed on Jul. 5, 2010.
(60) Provisional application No. 61/282,010, filed on Dec. 2, 2009.

(51) Int. Cl. G06F 17/00

(52) U.S. Cl. 715/229; 715/243

(57) ABSTRACT

A multi-channel publishing system for publishing tagged content in a plurality of versions via a plurality of channels, comprises: an input for tagged content; an input for receptacles of intelligent layout rules, the receptacles comprising cells associated with tags, the cells being optimized within the receptacles for respective versions or respective channels; a tagged content insertion unit for inserting the tagged content into the cells of the receptacles according to the tags, the receptacles actively responding to the content insertion by adjusting the cells to allow fitting of the content, the adjusting being constrained by at least one intelligent layout rule, thereby to form the plurality of versions of the tagged content optimized for respective output channels; and a publishing unit for outputting the plurality of versions.

### RELATED APPLICATIONS

This application claims the benefit of priority under 35 USC 119(e) of U.S. Provisional Patent Application No. 61/361,453 filed Jul. 5, 2010, and of U.S. Provisional Patent Application No. 61/282,010 filed Dec. 2, 2009. The contents of the above applications are incorporated herein by reference in their entirety.

### FIELD AND BACKGROUND OF THE INVENTION

The present invention relates to a system and method for multi-channel publishing.

We talk today about multi-channel publishing, when one wishes to make the same content available via different channels, for example via print, Internet, touch-pads, and mobile phones.

Multi-channel Publishing provides different versions of the same content which have been formatted for delivery in different physical channels such as web HTML, web and email PDF, traditional print, wireless handheld devices, and cell phones. The term “network publishing” is also used. Another way to look at channels is to regard them as different audiences or types of users, and such may require changes in the presentation.

Different channels may also include different languages. Providing the content in different languages is not merely an issue of translating the content but also requires variation of the presentation.

An extreme case of multi-channel publishing is One To One publishing, in which content is published for and according to customized requirements of a single user. In this case content from various sources may be collated and formatted according to profiles of specific individuals.

The classic process for multi-channel publishing, requires data gathering, cleanup, tagging, formatting, optimizing, and packaging.

Data gathering involves obtaining the content from the various sources, image, pdf text, print etc.

Tagging the data involves identifying metadata, and finding data structure and hierarchy. Finding the data structure involves identifying features such as headers, by-lines, summaries, data hierarchy and semantic tags to define the content as sport, news etc.

Formatting involves taking the tagged parts of the content as identified above and making a complete document therefrom. Thus the print version may be a newspaper. A web version may be a website in which each article appears as a headline and a short sub-headline on an index page, which can be clicked to give the full article on a page of its own. A version for mobile telephones would have to provide less information per page, particularly in regard to the index page, due to the smaller size of screens.

The content is finally packaged in various formats, Word, PDF, HTML, etc in versions suitable for each medium

In any event each medium gives a reading its own unique experience. Multi-channel publishing has the challenge of finding a way of formatting the same content for each medium so as to present the content in a way that takes best advantage of each medium. The data may preferably be presented in each medium in a way that allows a user to find the parts of interest easily.

In multichannel publishing, the data requires to be optimized for each medium, meaning the data needs to be defined in the best way to fit the device. Thus the electronic book product Kindle™ has a non-standard shape of screen, the Iphone™ has a small screen but larger than a standard telephone screen, traditional print has various combinations of large pages and high resolution, eReaders utilizing E Ink technology designed as electronic newspapers, are large but currently display black and white only. The popular Adobe Flash™ video playing format generally works on computers and is currently very likely to be supported by users, so a multi-channel publisher may well wish to use this format for his web version. However, Adobe flash is not available on the Iphone™, so if intending to provide the same video to Iphones, the appropriate format migration is needed.

The preparation of the different versions from the original content is a long and expensive process. Most is currently done manually and the operation is not scalable. It is quite common for the Publisher of a newspaper to produce several print versions of his newspaper over the course of a day, and to produce an online version which is regularly updated, so that multi-channel publishing becomes a major task.

### SUMMARY OF THE INVENTION

The present embodiments provide a multi-channel publisher which obtains content and fits the content using intelligent layout rules, the rules being specific to any given output channel, format or device.

According to one aspect of the present invention there is provided a computerized multi-channel publishing system for electronic publishing of tagged content in a plurality of output versions via a plurality of channels, the system comprising:

an input for receiving the tagged content;

a plurality of intelligent layout rule receptacles, each receptacle comprising embedded cells associated with tags, the cells for accommodating the tagged content, the cells able to carry out the accommodating of tagged content according to predetermined rules selected for a respective output version, thereby to provide receptacles each modified for a respective output version;

a tagged content insertion unit operative for inserting the tagged content into each of the receptacles, in each receptacle the cells adjusting themselves according to the predetermined rules to allow fitting of the content in each receptacle, thereby to form the plurality of versions of the tagged content optimized for the respective output version; and

a publishing unit for outputting the plurality of versions.

In an embodiment, each output version has a condition for readability and the predetermined rules comprise layout conditions to fulfill the readability condition.

In an embodiment, each output version is associated with an output device having a screen of a given size and wherein the layout conditions comprise a minimum text size on the screen.

In an embodiment, each output version is associated with an output device having a screen of a given shape and wherein the layout conditions comprise filling of the given shape.

In an embodiment, the accommodation comprises cells adjusting their sizes according to respective tagged content set therein.

The system may comprise a rule derivation unit for accepting as input user templates dedicated to each of the versions and deriving the rules from the templates.

In an embodiment, one of the predetermined rules is applied to all of the versions.

The system may comprise a plurality of receptacles for different parts of a same version.

In an embodiment, respective receptacles comprise cells for text and cells for images.

In an embodiment, the cells for text are arranged as columns and respective ones of the predetermined rules allow one of the cells for images to extend over variable numbers of the columns.

In an embodiment, the cells for images comprise functionality to resize images inserted therein in accordance with corresponding ones of the predetermined rules.

According to a second aspect of the present invention there is provided a computerized multi-channel publishing method for electronic publishing of tagged content in a plurality of output versions via a plurality of channels, the method comprising:

receiving the tagged content;

providing a plurality of intelligent layout rule receptacles, each receptacle comprising embedded cells associated with tags, the cells for accommodating the tagged content, the cells able to carry out the accommodating of tagged content according to predetermined rules selected for a respective output version, thereby to provide receptacles each modified for a respective output version;

inserting the tagged content into each of the receptacles, in each receptacle the cells adjusting themselves according to the predetermined rules to allow fitting of the content in each receptacle, thereby to form the plurality of versions of the tagged content optimized for the respective output version; and outputting the plurality of versions.

In an embodiment, each output version has a condition for readability and the predetermined rules comprise layout conditions to fulfill the readability condition.

In an embodiment, each output version is associated with an output device having a screen of a given size and wherein the layout conditions comprise a minimum text size on the screen.

In an embodiment, each output version is associated with an output device having a screen of a given shape and wherein the layout conditions comprise filling of the given shape.

In an embodiment, the accommodation comprises cells adjusting their sizes according to respective tagged content set therein.

The method may comprise accepting as input user templates dedicated to each of the versions and deriving the rules from the templates.

In an embodiment, one of the predetermined rules is applied to all of the versions.

The method may comprise providing a plurality of receptacles for different parts of a same version.

In an embodiment, respective receptacles comprise cells for text and cells for images.

In an embodiment, the cells for text are arranged as columns and respective ones of the predetermined rules allow one of the cells for images to extend over variable numbers of the columns.

The method may comprise enabling the cells for images to resize images inserted therein in accordance with corresponding ones of the predetermined rules.

Unless otherwise defined, all technical and scientific terms used herein have the same meaning as commonly understood by one of ordinary skill in the art to which this invention belongs. The materials, methods, and examples provided herein are illustrative only and not intended to be limiting.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Implementation of the method and/or system of embodiments of the invention can involve performing or completing selected tasks manually, automatically, or a combination thereof.

Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram illustrating a multi-channel publisher device according to the present embodiments;

FIG. 2 is a simplified schematic diagram illustrating automatic repagination of content according to embodiments of the present invention;

FIG. 3 is a simplified schematic diagram illustrating an exemplary index page template for the index page shown in FIG. 2, according to embodiments of the present invention;

FIG. 4 is a simplified schematic diagram illustrating an exemplary index page template for an internal index page in the publication illustrated in FIG. 2, according to embodiments of the present invention;

FIG. 5 is a simplified schematic diagram which illustrates an article page template suitable for the publication illustrated in FIG. 2, according to an embodiment of the present invention;

FIG. 6 is a simplified schematic diagram which illustrates a flow chart of a process for multiple channel publication according to an embodiment of the present invention;

FIG. 7 is a simplified schematic diagram illustrating apparatus for multi-channel publication according to an embodiment of the present invention;

FIG. 8 is a simplified diagram illustrating examples of the same content published for different output devices according to embodiments of the present invention;

FIG. 9 illustrates the multi-channel publisher of FIG. 8 combined with an XML distiller and data repository;

FIG. 10 illustrates an overall publishing environment with a multi-channel publisher according to the present embodiments inserted therein;

FIG. 11 illustrates the web application server of FIG. 10;

FIG. 12 illustrates a publication page of the paginated content of FIG. 10, adapted in five different ways for different devices or media, in accordance with an embodiment of the present invention;

FIG. 13 illustrates a printed page of a publication where content is applied to a template to which the present embodiments may be applied;

FIG. 14 illustrates three internal page templates applied to paginated content of the publication of FIG. 13;

FIG. 15 illustrates content applied to a front page template and an internal page template, according to embodiments of the present invention;

FIG. 16 shows a front page template and an article page template according to embodiments of the present invention; and

FIG. 17 illustrates tagged content transformation by the XML distiller of FIG. 9 which reveals document structure and semantics.

### DESCRIPTION OF THE PREFERRED EMBODIMENTS

The present embodiments comprise a method and apparatus for allowing for computerized production of different versions of content, based on intelligent layout rules and receptacles for receiving and arranging content based on the rules, the rules defining each version based on computerized analysis of the original content.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

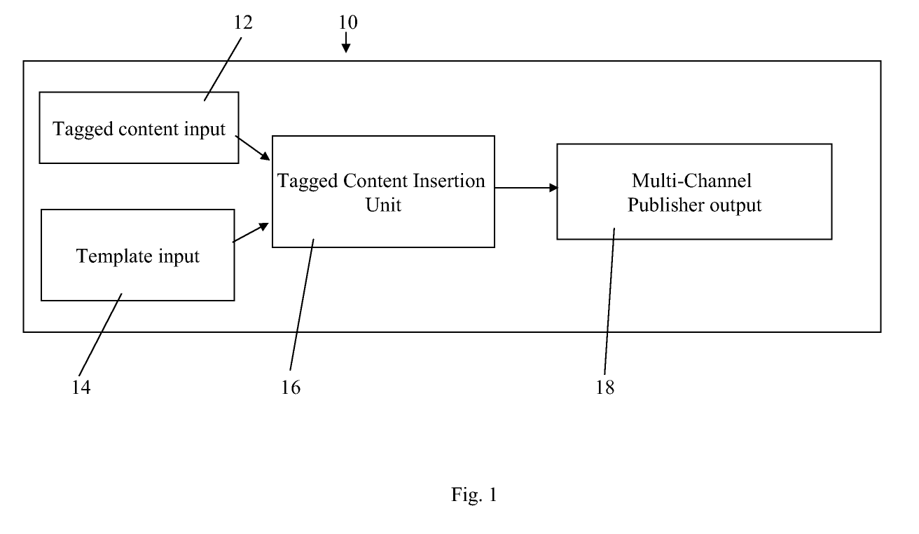

Reference is now made to FIG. 1 which illustrates a multi-channel publishing system 10 for publishing tagged content in a plurality of versions via a plurality of channels. The system comprises an input 12 for receiving tagged content. The tagged content may be hierarchical, or have other interrelationships, for example the tagged content may be newspaper content having individual articles which each have a heading, a sub-heading, a byline, a picture, a summary and the article itself. The tags indicate these relationships. Tagging may comprise XML tagging, or metadata, and may relate to structure and content hierarchy of the data.

The embodiments provide automatic recognition of relations between entities, say from within an original printed edition . The relationship information may then be utilized to improve the presentation on the different output channels.

Features which may contribute to the automatic recognition include:
1. Article structure.
2. Article importance, which may be deduced from location, title size, illustration size and the like—thus an article beginning on the front page may be recognized as more important than an article beginning on the inside. An article on the front page and with a large headline and picture may be regarded as being of greater importance than one with a smaller headline or no picture.

3. relationships between different articles, for example embedded articles, and interlinked articles. For example there may be a theme for which one article is in favor and the other is against.

4. Relationship information may be gleaned from original formatting specifics (e.g. bold, italic,)

A template input 14 may be provided for accepting templates indicating how content should be presented for a given version. The system may then derive intelligent layout rules from the template, so that tagged data may be inserted into a receptacle and the layout may be governed by the derived rules so that the result carries the look and feel of the template.

As discussed in greater detail below, multiple templates may be provided for presenting content within one issue of a publication. For example there may be templates per each section of a newspaper, or templates for indexes for each section and templates for content pages per section, or specific templates to present articles with big graphics and articles with small photos, Likewise templates may present long textual articles and templates may present infographics say for weather, or a television channel guide, . . . ). The system may dynamically choose a most appropriate template to present the current information item.

The receptacles may include cells associated with the tags used for the content. The rules govern the cells behavior so that content is accommodated in such a way as to retain the template layout and also to take into account the layout requirements of the output device. The templates provided may themselves take into account the output device, and the rules, in retaining the look and feel of the template, may thus automatically accommodate the output device. For example, specific templates may be provided for a general 3G mobile telephone, for specific smartphones, for electronic readers of various kinds and for regular and widescreen laptop and desktop computers. Each of the above mentioned output devices have different sized and shaped screens and different graphics handling abilities, and thus different readability requirements. As well as readability requirements the available space in a wide screen requires filling in a different way from a conventionally shaped screen. A small screen such as that on a mobile telephone or smart phone cannot take the amounts of data that a regular screen can take without becoming unreadable. Electronic readers are often shaped to provide the two-page appearance of an open book, and this shape too may require specific accommodation in order to fill. Certain electronic readers may lack ability to handle color or may be limited in other ways in their handling of graphics.

Thus the template and rules may ensure that the readability requirements of the particular screen shape and size are met.

As well as electronic output the data may be intended for printed output, so that the output device may be a printer. Again printed output has certain presentation requirements. There may be limitations on graphic handling, and text sizes may be required to conform to readability requirements.

In light of the above, the layout defined by the receptacle including the cells is optimized for particular versions of the content it is desired to publish or for different output channels on which it is desired to publish the content. Thus different receptacles are provided to make versions of the data suitable for printed output and for web output to different kinds of network devices and for mobile telephone output. Specific receptacles may be provided for specific output devices, such as widescreen, or for specific mobile telephones such as the Iphone™.

A tagged content insertion unit 16 inserts the tagged content into corresponding cells of the receptacles according to the tags. The insertion unit operates the receptacles to actively respond to the content insertion by intelligently adjusting the cells to allow fitting of the content. The adjusting may for example involve increasing the width allowed for a picture to spread over a larger number of columns, increasing or reducing the size of a headline, and numerous other adjustments, as will be discussed in greater detail below. The adjustments may be constrained by a rule which is associated with the specific receptacle, or with the associated output channel or obtained from a template associated with the version being produced. The rule may limit whatever adjustment is made to conform to the particular output version or channel and its readability, shape, graphics handling or other requirements.

Using multiple receptacles for the same tagged data, each based on a different template, it is possible to obtain multiple versions of the tagged content, which have been automatically optimized for different output channels. A publishing unit 18 outputs these different versions for the particular output channels. Thus versions for a website may be distributed to the website server to form a hierarchy of pages within the website. Versions for mobile telephones may likewise be distributed to a server to form a hierarchy of pages. Versions for print may distributed directly to a printer, or may be output over the network in print-ready versions.

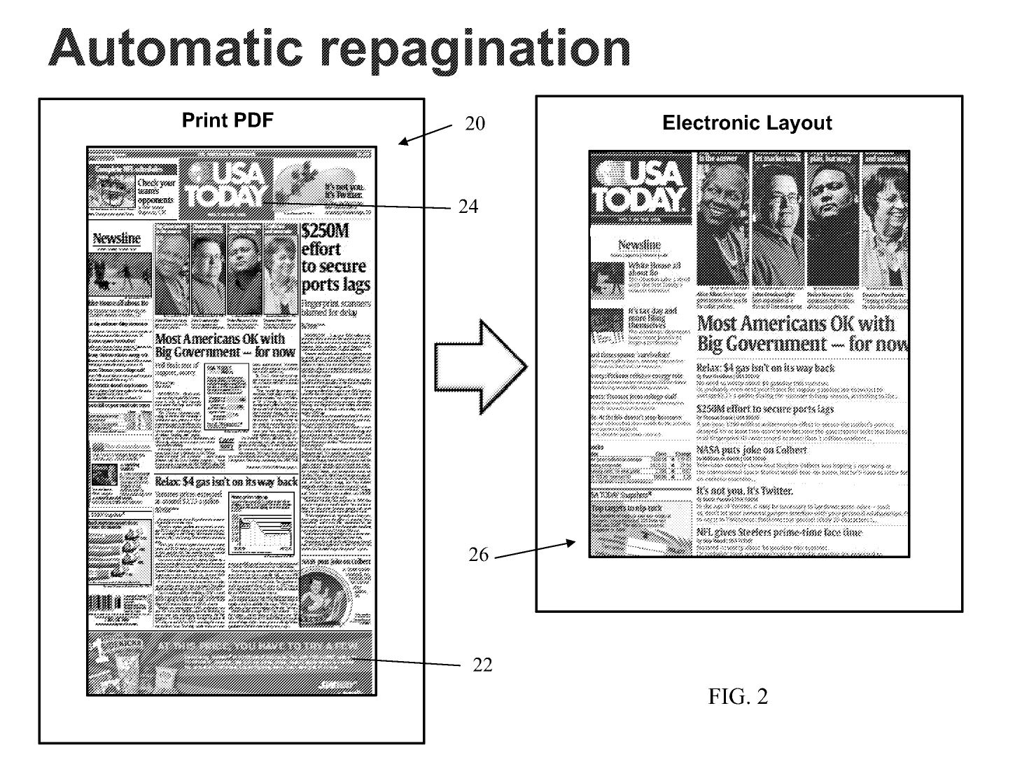

Reference is now made to FIG. 2 which illustrates two versions of the same content. A print PDF version 20 of the content is shaped to fill the shape and size of a standard tabloid newspaper page so that the text is readable at that size. Advertisements which are paid to appear in the printed version are included 22. Each headline fills one or two columns and is followed by corresponding storyline content, which may end on the current page or continue onto a following page. A banner 24 identifies the publication.

A second version 26 is an electronic layout of the same page. The electronic version includes the same banner and the same headlines. However the page is a contents page and each headline is a link to the story with a sub-headline or teaser. The target screen size is smaller so there is less text on the page and the images are relatively larger. The overall shape of the screen is different from that of the tabloid page so the text and images are modified to fill the changed shape.

More generally, the publishing unit may output content for the following main publishing channels:

Web Content Applications (HTML), where the system automatically produces rich-style Web Content Applications, for On-line periodicals and books, digital archives, and more;

Paginated Content in say PDF format, where the system automatically builds print-quality page layouts. This latter is suitable for periodicals, text books and catalogs. PDF is also suitable for customized publishing templates—to maintain the publisher's brand.

XML content (ePub), in which the system may transform any source content into XML formats—ePub, ATOM, RSS. The format may provide basic content presentation, and is particularly useful for trade books.

In one embodiment a text-to-speech conversion is used to produce an audio version.

Automatic cleanup of content and tagging are known from existing patents and applications of Olive, including U.S. Pat. No. 6,810,136, U.S. Pat. No. 7,418,653, U.S. Pat. No. 7,600,183 and U.S. patent application Ser. No. 11/330,113, the contents of which are hereby incorporated by reference as if fully set out herein. In the above patents and applications it is taught that content of different types have specific formats and hierarchies that may be recognized and tagged.

Data source may include PDF and image documents, OCR and document structure recognition may be used, and vector graphics and images may be recognized.

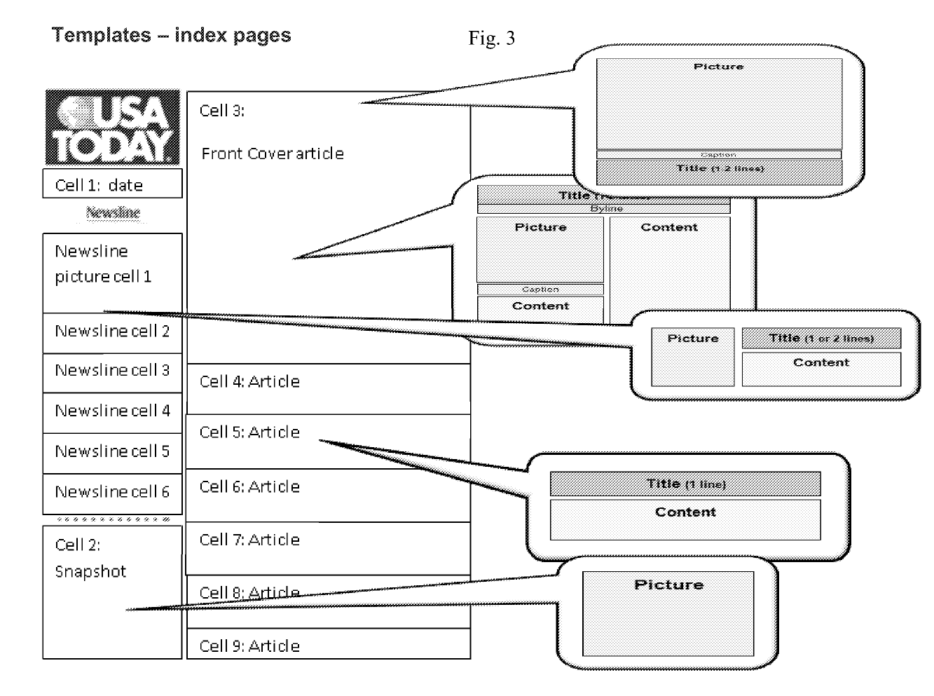

Referring now to FIG. 3, and in the present procedure a template is prepared for the output channel. The template contains the publisher's generalized format for the given output channel, and contains regions for specific tagged sections to insert themselves. The template is channel specific and provides a framework to build the content anew from logical and business rules so that the content is optimized for the specific device or output channel. The rules define ways of setting out tagged content for the specific device. Rules may additionally be set up for the specific company. Thus all publications of a specific company may have a banner across the top of the page. The exact banner used may be optimized for different devices, by including different versions on the template.

FIG. 3 illustrates a template 28 suitable for providing the contents page 26 of FIG. 2. The template comprises certain fixed items such as banner 30 carrying the publication name and sub-banner 32 carrying the sidebar title. Remaining cells are dedicated to sidebar news titles and to main and subsidiary news articles. Some of the cells are complex cells taking picture, title and content items, or picture, caption and title. Other cells take content and title, or just a picture or just content. Exemplary intra-cell layouts are illustrated by the callout shapes to the side of the template. As this is a content page, all of the titles are links to content which appears on later pages.

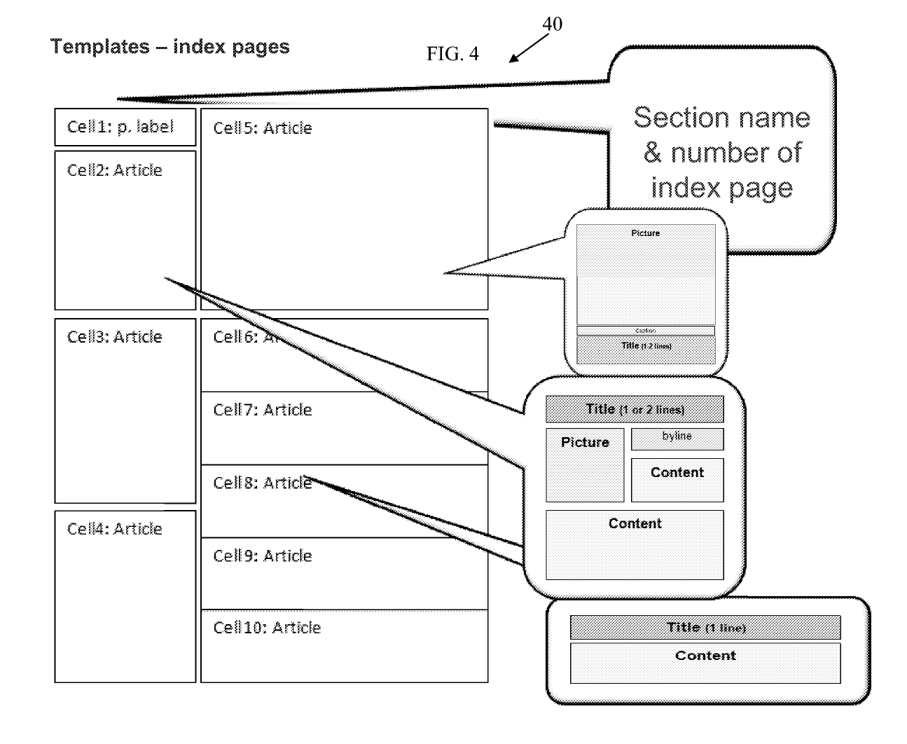

FIG. 4 illustrates a template 40 suitable for providing an internal contents page in the same publication. A first cell, cell 1, provides a section name, for example the page may be the index to the business or sports section. Cells 2, 3 and 4 are sidebar articles and cells 5 to 10 are main articles. Cells 2 and 5 may be complex cells including three or more of picture, caption, title, by-line and content. Other cells may include just title and content, or just a title, as appropriate.

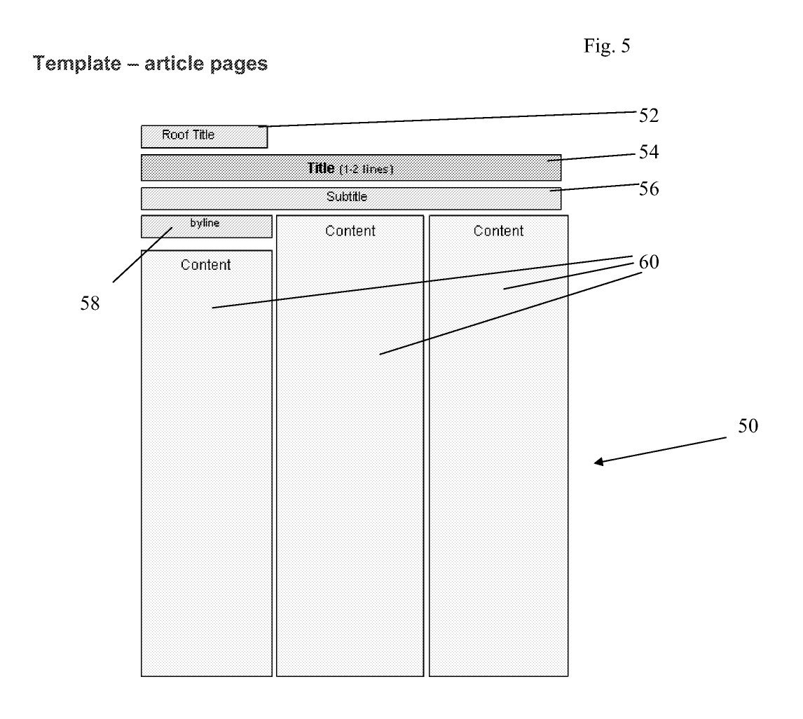

FIG. 5 illustrates a template 50 suitable for an internal article page in the same publication. Here there is a cell 52 for a roof title, a cell 54 able to take up to two lines for an article title, a cell 56 for a sub-title, a cell 58 for a by-line, and cells 60 for three columns of content. Should the by-line cell 58 be empty then the first of the content cells 60 automatically extends upwards to take its place.

The receptacle may be prepared after receiving from the user an example of the layout he would like.

An automatic editor makes editing decisions, for example where to put the picture, how to size the picture for the given device, ways of making the picture look realistic. The automatic editor uses machine intelligence and carries out a process which is different for each output channel or device.

The automatic editor working through a receptacle can produce a rich and dynamic website. In general news websites are already based on templates, and content is poured in from a database. However the insertion of content is automatic, requiring user intervention if anything more sophisticated than direct presentation of the data is required Links Templates have typical HTML quality which can be low and the HTML linking itself has to be actively inserted. Location of an image has to be selected. The HTML, created in this way, gives a different feel from print, and takes away from the feel that a specific publisher may wish to have extend across all of his publications. Use of the receptacle and automatic editor, in essence an intelligent template, can provide a website that gives a specific feel to it, and can intelligently select suitable formatting and the most suitable compression for delivery without losing the overall feel. The intelligent template may thus provide the same overall feel on the Web that the printed version of the publication provides.

The receptacle is prepared from a sample that the publisher provides. The publisher simply shows how he wants his content to appear on each device.

The receptacle may include template features such as a logo at the top, a side column with the contents, a lead story on the center of the page. A separate template is prepared per device. The receptacle for an Iphone™ would have to be varied in that the Iphone™ has no room for a side column. This feature however could be replaced by the user of buttons at the bottom of the screen instead.

A printed newspaper, and the associated web version, may comprise different parts each using different receptacles, thus a business part may have one receptacle, a sports section may use a different receptacle, a literature supplement may use yet another receptacle. Each may have the same or different logos as desired. Typically a receptacle may be provided for an index page and a separate receptacle may be provided for a content page. Again the index receptacles may be different for different parts or sections. The user then presses on a story on the index page and receives the full story on the corresponding content page.

More particularly, for each section or part of a publication, if it has parts, a number of index pages are set up. Index pages are pages with articles teasers, a title, a sub-heading or a few lines of the article and sometimes an image.

The receptacle for the index pages defines cells with constant locations for the article teasers.

In some cases the publisher may wish to provide two receptacles for index pages—one for the section cover page and another for the rest of the article teasers. Each section may have its own index page templates.

The user then clicks on a teaser and jumps to the page or pages with the entire article.

Once the receptacle has been provided the issue arises of how to set the content onto the receptacle.

The receptacle has cells, one kind of cell for a picture, another kind of cell for text. Cells are dynamic and fill unused space, so that it is possible for the intelligence to decide what to do when titles are bigger or smaller, or to decide whether a picture should take two columns. The template adapts to include a byline, or to deal with the article that has no picture.

The receptacle may decide which article goes where on an index page. Thus certain articles may be tagged as leading articles, or latest news or the like and may thus be assigned to particular locations. There is an option to give conditions for regular features, which may be recognized by the system based on a constant roof or title or byLine, or simply by being the largest item in the section.

A receptacle for an e-reader may for example define suitable screen dimensions and orientation. Image optimization may be according to the specific device capabilities regarding color and B&W screens and resolution. The content may be optimized for bandwidth requirements, and packaging may be in different output formats—for example EPUB, ATOM, RSS, NITF, or METS.

Cells may have constant dimensions and locations. The layout inside a cell may be dynamic, and the content may start where the content above ends.

In an embodiment, a part of the last index page in a section may remain blank, when for example all the articles have been referenced. In another embodiment the template may look for certain types of tagged content as filler so that there is no white space.

Decorations, such as lines between cells, backgrounds or other constant elements may be defined as part of the template, and may be independent of content.

Pictures, if any, may be downscaled to fit a given width. This is particularly true of the content pages. The width may be defined by the output channel. Content may be reflowed to occupy any available area after resizing of other items. A next page may be set up for continuation if necessary, ad this may be achieved by a second or internal template.

Options such as navigation buttons for going back to the home page or the section index or to go to page x of y may be provided for the relevant channels.

The receptacle is page oriented but clearly on mobile telephone type devices the page size is limited, so that either the stories have to be shorter or they have to take up more pages. Receptacles can be provided which are dedicated for widescreen.

A receptacle is a framework for the content and guides the style of the final publication based on the content provided.

Multiple output versions allow for paid content, for Micro-content, and for targeted advertising. The system may be integrated with purchase, fulfillment, DRM and payment systems. The system may be combined with content usage analytics to discover who read what, where and when. The content may be archived and content management may be applied to seamlessly creates searchable go-forward and historic content archives.

As regards targeted advertising an embodiment may enable enhanced targeted and contextual advertising.

A share and collaborate feature may enable communities to share annotations and ideas over text, etc. for example allowing multi-channel publishing of multi-contributor input.

One use of the present embodiments is for personalization. A user profile allows the system to choose suitable content for the given user. The chosen content may then be fitted onto the receptacles in the automatic process described above, to provide a publication optimized for the profile of the given user. Personalization is particularly suitable for the relatively new medium of the electronic reader.

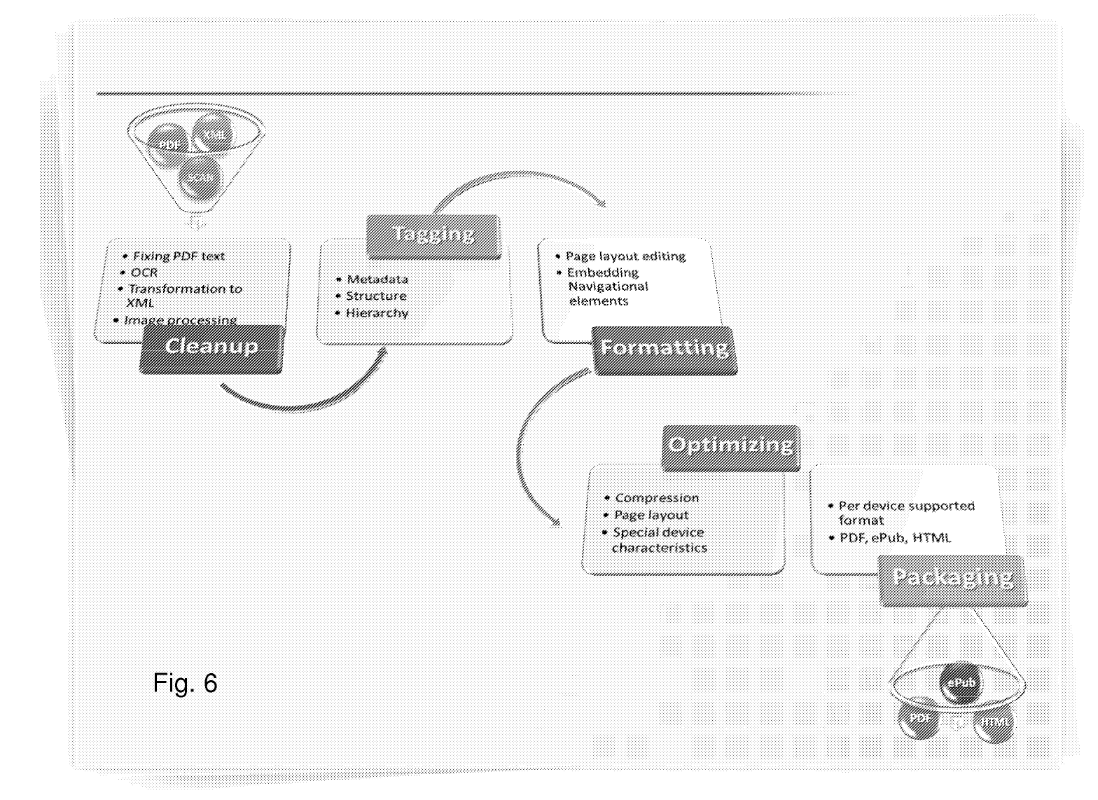

Reference is now made to FIG. 6 which is a simplified flow diagram showing a procedure for obtaining content, tagging and multichannel publishing. Content is obtained from sources such as a PDF file. The PDF files may be difficult to read in many cases. For example any of the following problems may be present in such a source. Inherited problems with PDF text are:
Incorrect text encoding;
Bad or unclear word separation;
Bad or unclear reading order;
Special effects may be present which make the text difficult to read;
Vectors may be used instead of text in the document; or
Images of text may be present instead of encoded text.

Alternatively the data may have been scanned so is almost certainly incomplete and as a further alternative may be incomplete XML data. In all of these cases a cleanup stage may be required. After cleanup a stage of tagging is provided to add tags and metadata in order to recognize structure, hierarchy and other relationships in the content. Use of tags and metadata may allow correct text flow and presentation, and improve search accuracy. A formatting stage may then be based on the metadata and tagging and may build an infrastructure for content management. The infrastructure may then enable Digital Rights Management.

An optimizing stage may then change the page layout to fit the characteristics of different reading devices as discussed above, the relevant characteristics including screen size, color space and graphics handling abilities in general, and screen shape or configuration.

A packaging stage may then address issues such as cellular network bandwidth consumption limitations. An attractive page layout ensures good reading experience and branding. Suitable layout is useful for complex content, as in newspapers, magazines, catalogs, text books and more. Packaging may be provided in different output formats to support different devices, for example PDF, ePub, LIT, HTML, MS Word and more.

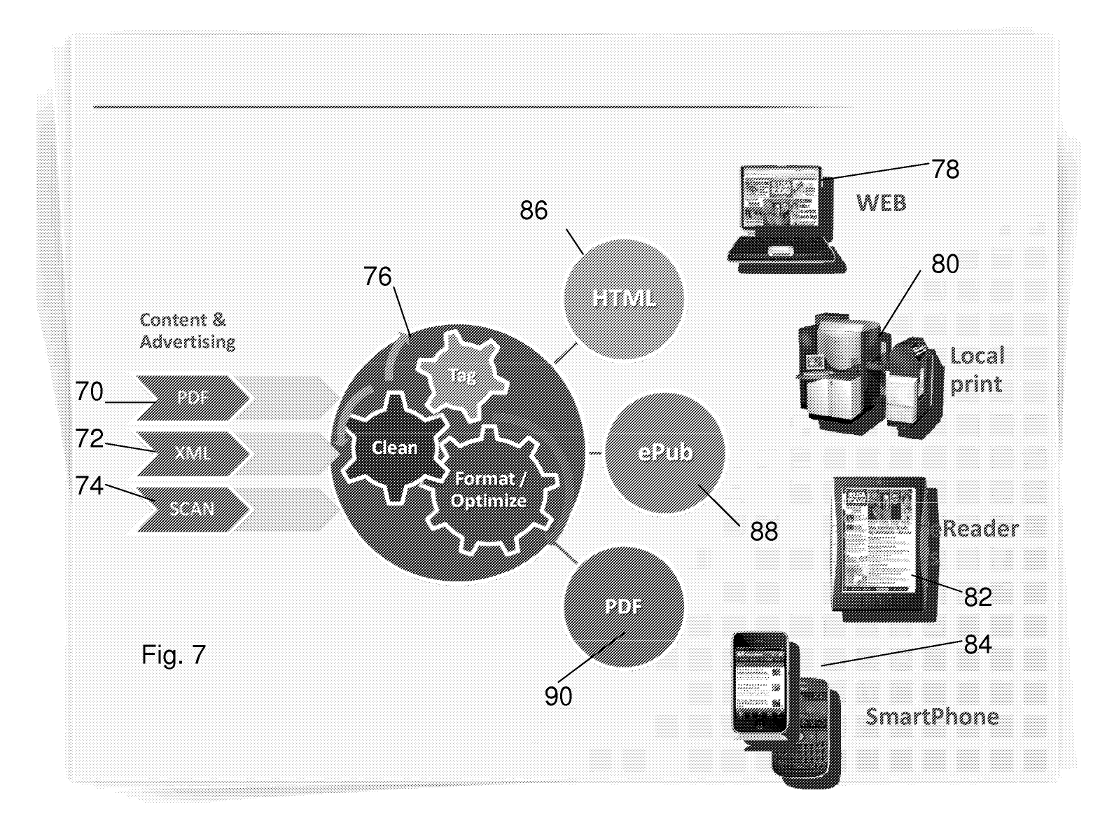

Reference is now made to FIG. 7, which is a schematic diagram illustrating a multi-channel publisher according to the present embodiments. Content, including advertising is provided as input. The input is PDF 70, XML 72 or scan data 74. The content is cleaned and tagged as described above in multi channel publisher 76 and output after formatting and optimizing for different devices or channels such as general web devices 78, a local printer 80, an electronic reader 82 and a smart phone 84. The output versions are provided in three different formats HTML 86, ePUb 88 and PDF 90.

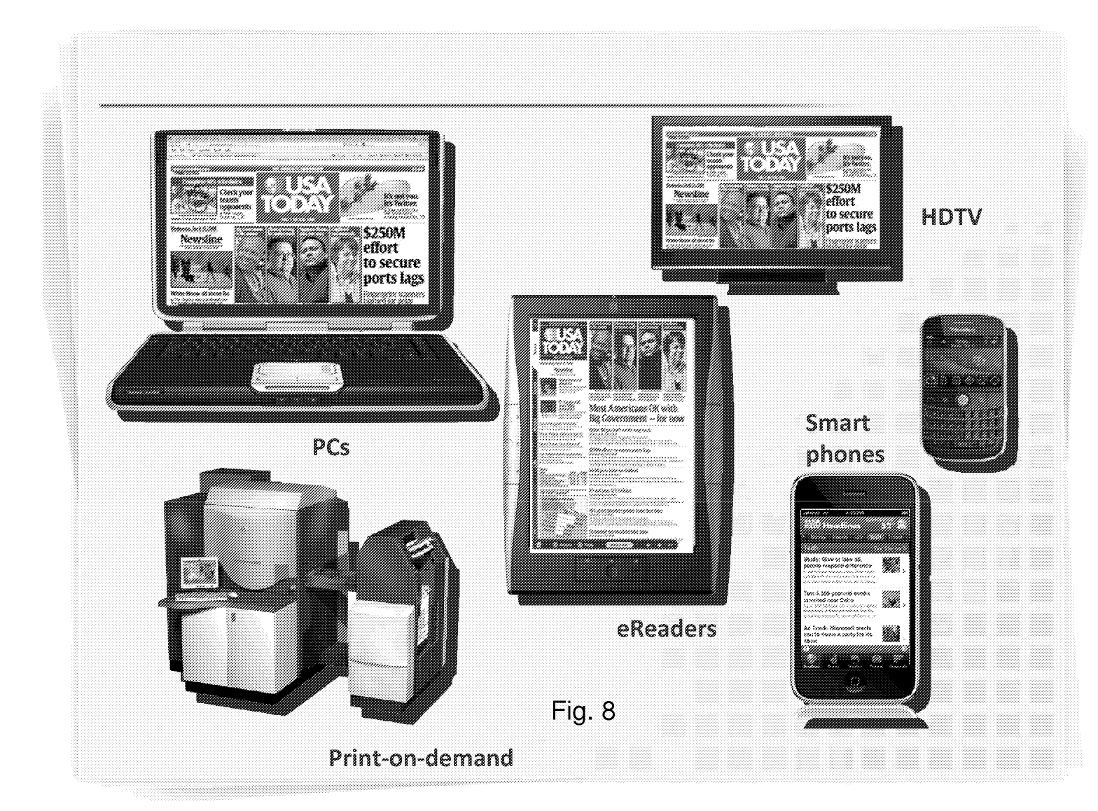

Brief reference is made to FIG. 8 which illustrates newspaper content being adapted for output on different devices. In general the use of the rules-based receptacle of the present embodiments allows different types of publications to be output over different types of devices, including personal computers, television and high definition television (HDTV), smart phones of various kinds, electronic readers personal computers. There may also be provided print on demand versions for which a printer is the output device.

In one embodiment, the formatting may include electronic translation. In general electronic translation requires checking and editing by a human translator, but be as it may a newspaper may use this system in order to be printed in different countries in multiple languages.

Newspapers, magazines, books, including text books, and business and professional publications may provide the content. Glossy magazines in particular have generally made little use of the Internet to date. One reason is that the essence of the publication lies in the relationship between the photograph and the text. Prior art systems do not substantially address the layout and thus multi-channel publication of a layout sensitive publication such as a glossy magazine has not been possible.

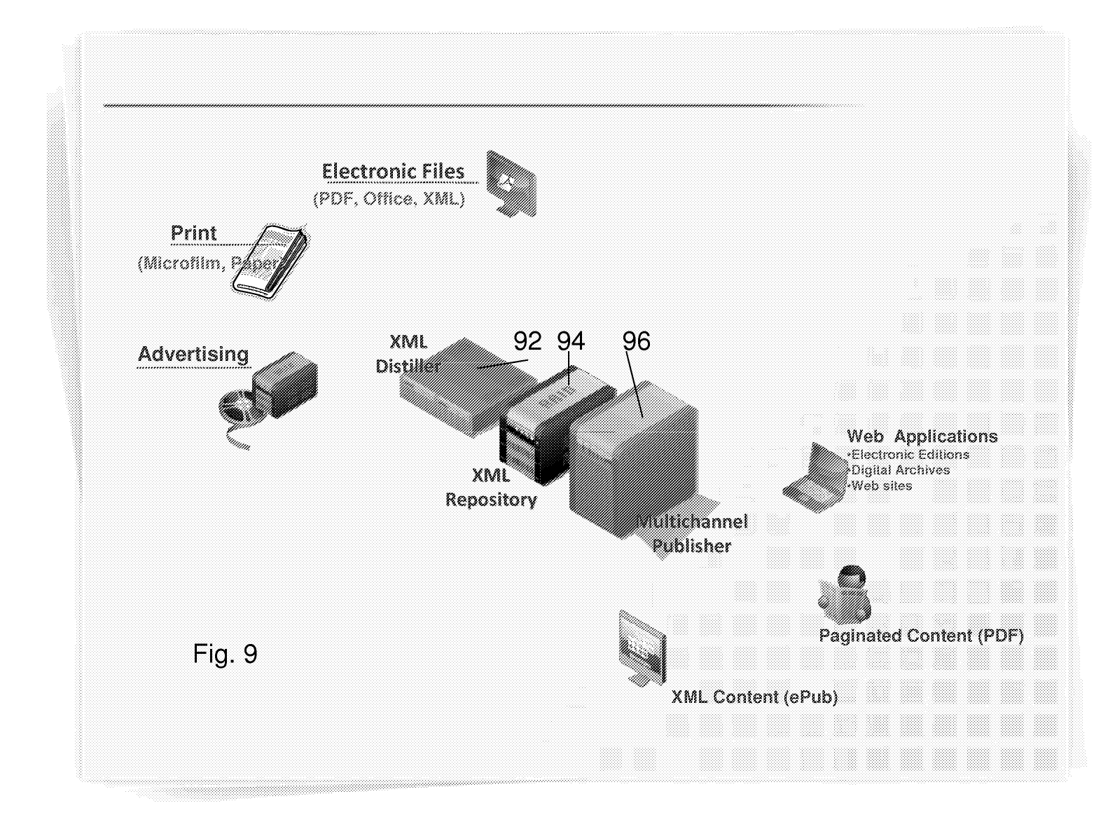

Reference is now made to FIG. 9, which illustrates an electronic publishing and data delivery platform according to the present embodiments. Print, electronic files and advertising media are cleaned and tagged etc in an XML distiller 92. The tagged content is then held in XML repository 94 until it is needed. RAID or any other suitable storage device may be used. Then the XML content is published by the multi-channel publisher 96 in the different versions according to the templates provided.

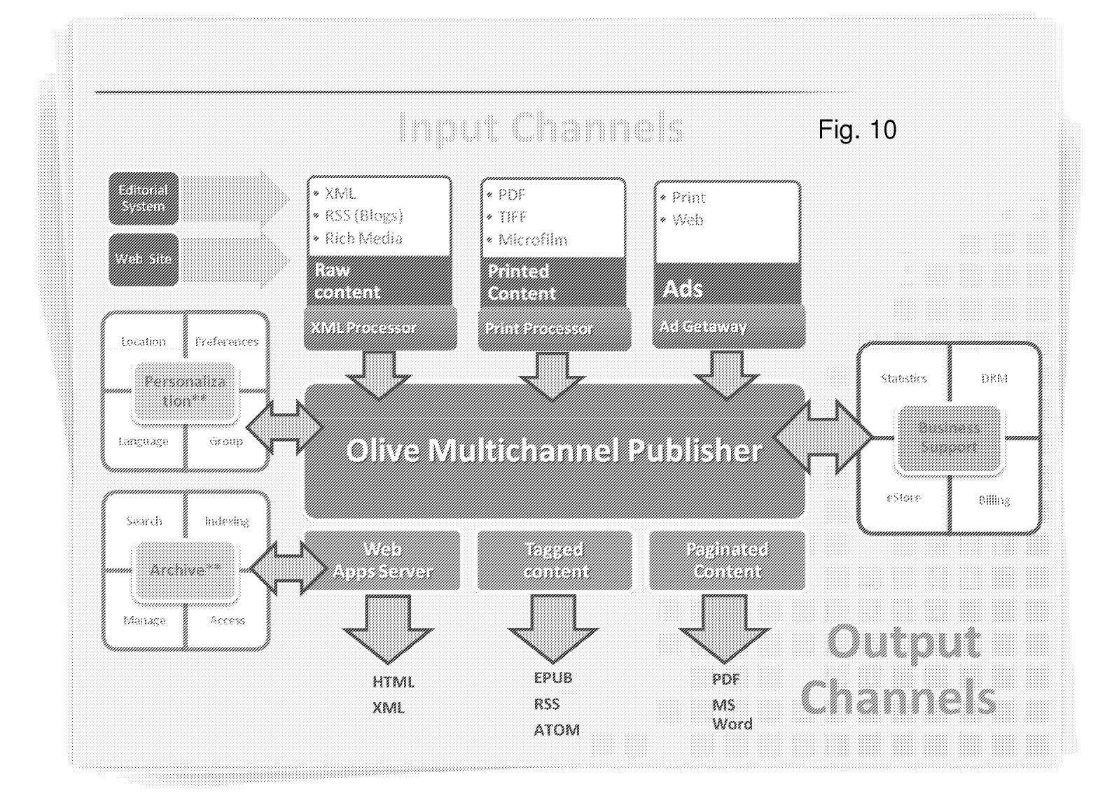

Reference is now made to FIG. 10 which is a schematic system diagram showing an integration of the multi-channel publisher of the present embodiments into the publishing environment as a whole. Web sites and editorial systems provide content. The content may be raw content, printed content and separately advertising content, each in different formats. The multi-channel publisher may then modify the content using the present embodiments for different output channels, as web content, paginated content or tagged content, using formats such as HTML, XML, EPUB, RSS, ATOM, PDF and those of well-known word processors. The content may be provided for personalization, that is according to specific rule sets for profiles of individuals, location, language, other preferences or group, or for rules provided by individuals. Alternatively the data may be provided for archiving or library purposes, with associated searching, indexing, management and access abilities.

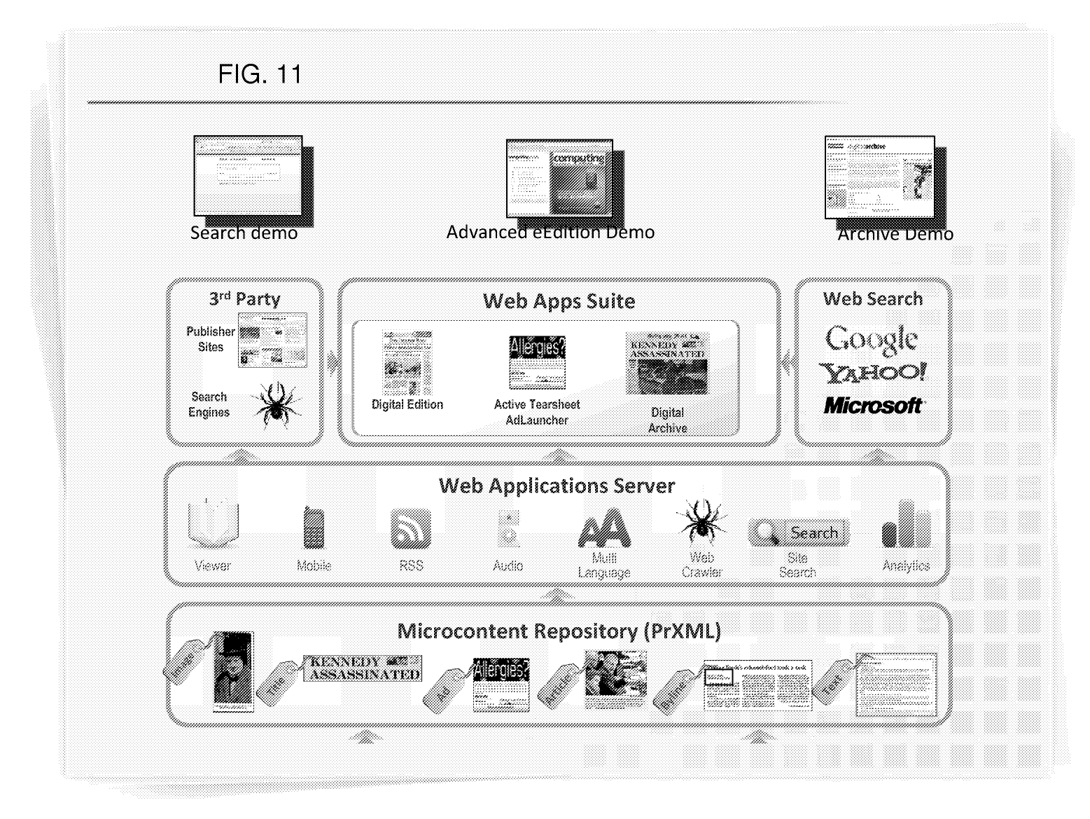

FIG. 11 illustrates the web applications server of FIG. 10 in greater detail. A web applications suite provides digital applications that may allow a third party publisher site to to publish his content and provide a search engine. The suite may support a web application server which specifically supports different output channels., such as multi-language, audio, RSS, mobile web and electronic viewers. The content may be made available for web crawlers and site searching, and analysis may be provided of the data use, say for the interest of advertisers.

A microcontent repository may allow access of individual items of the content, such as tagged images, tagged titles, tagged bylines etc.

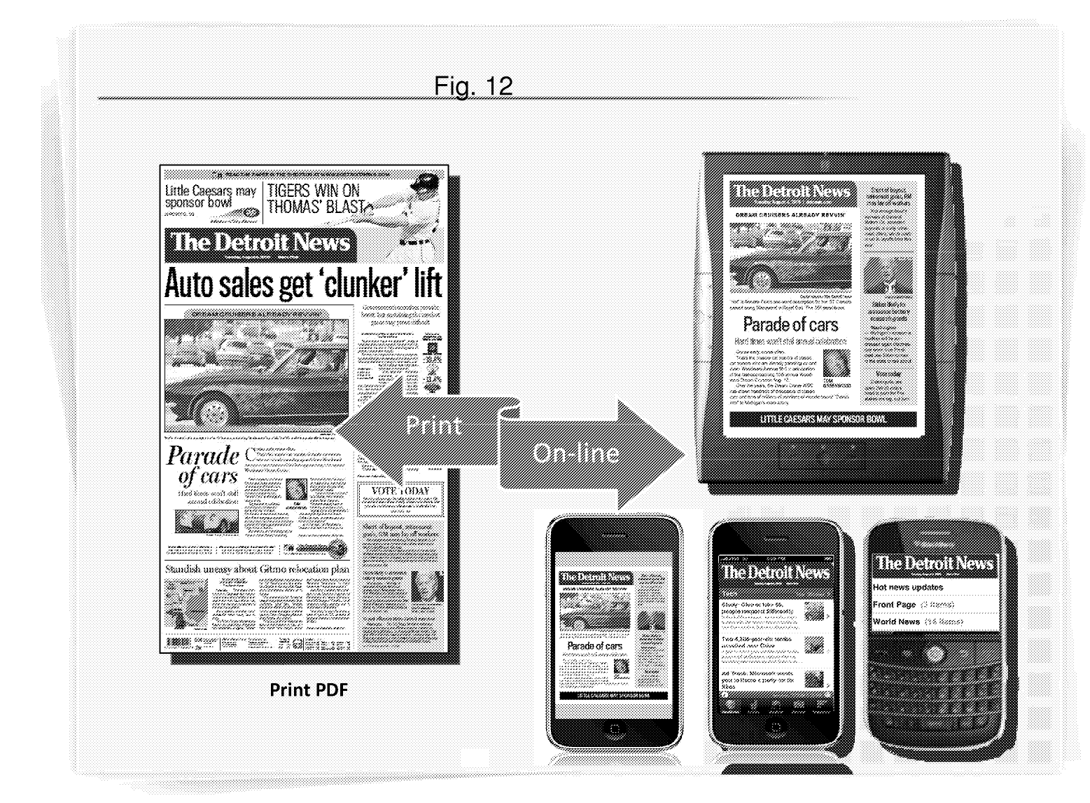

FIGS. 12 to 15 illustrate use of the paginated content output channel of the present embodiments. The original content is repaginated as described above for different output devices. In FIG. 12 the original print version is transformed into four different online versions, one in black and white for an electronic reader with no color handling ability, and three other versions for different mobile devices each with different shaped screens.

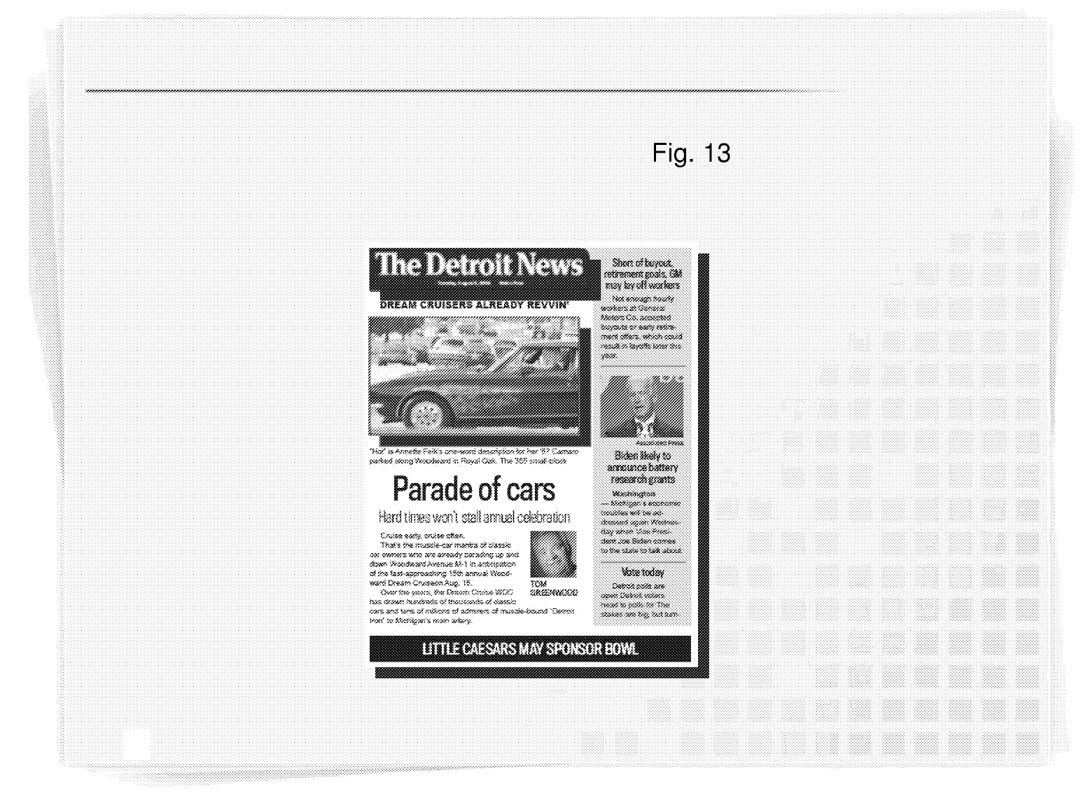

In FIG. 13 a sample publication is provided by the content publisher. The sample publication is automatically transformed into a template.

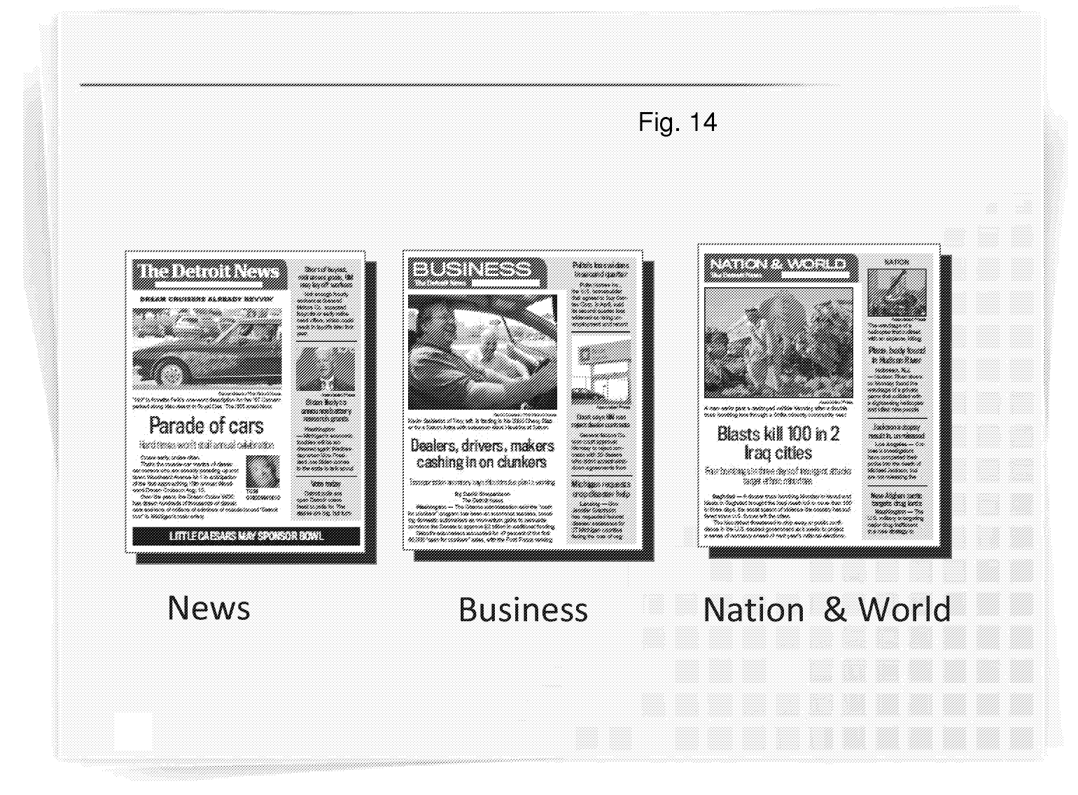

In FIG. 14 three different index pages are shown for different sections of a newspaper.

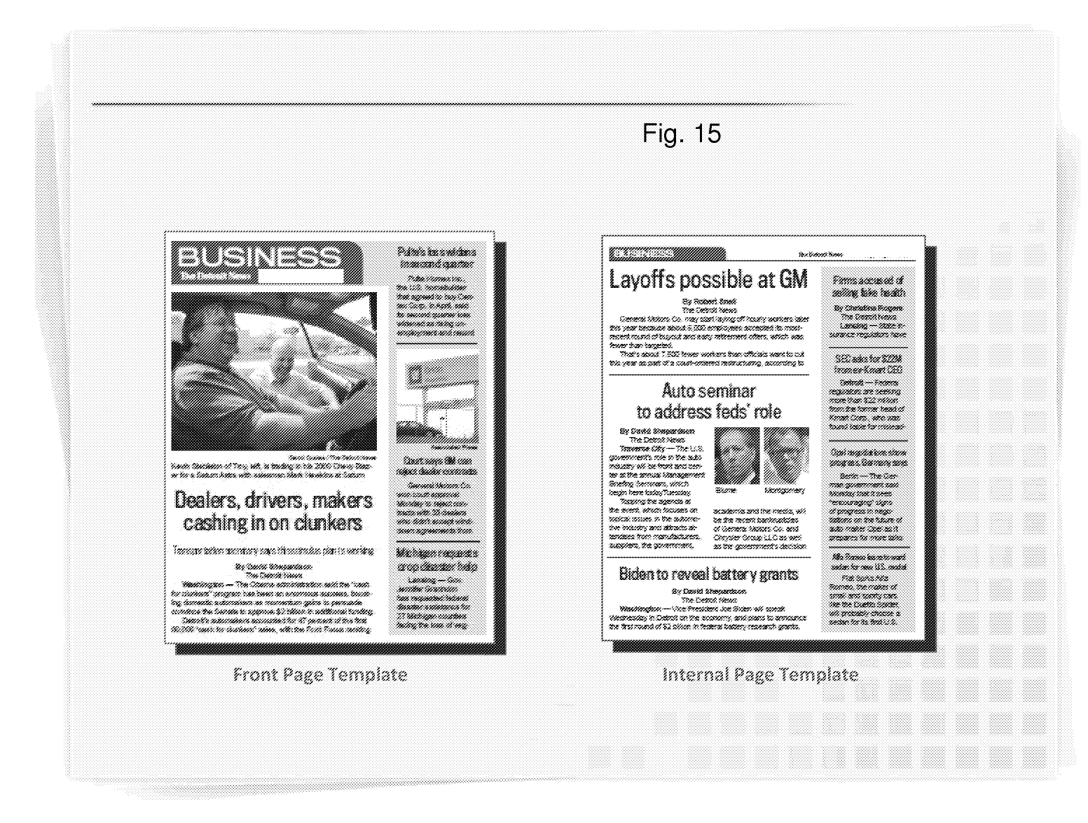

In FIG. 15, two different templates are shown for index pages of the business section, one for the front page of the business section and one internal index page template.

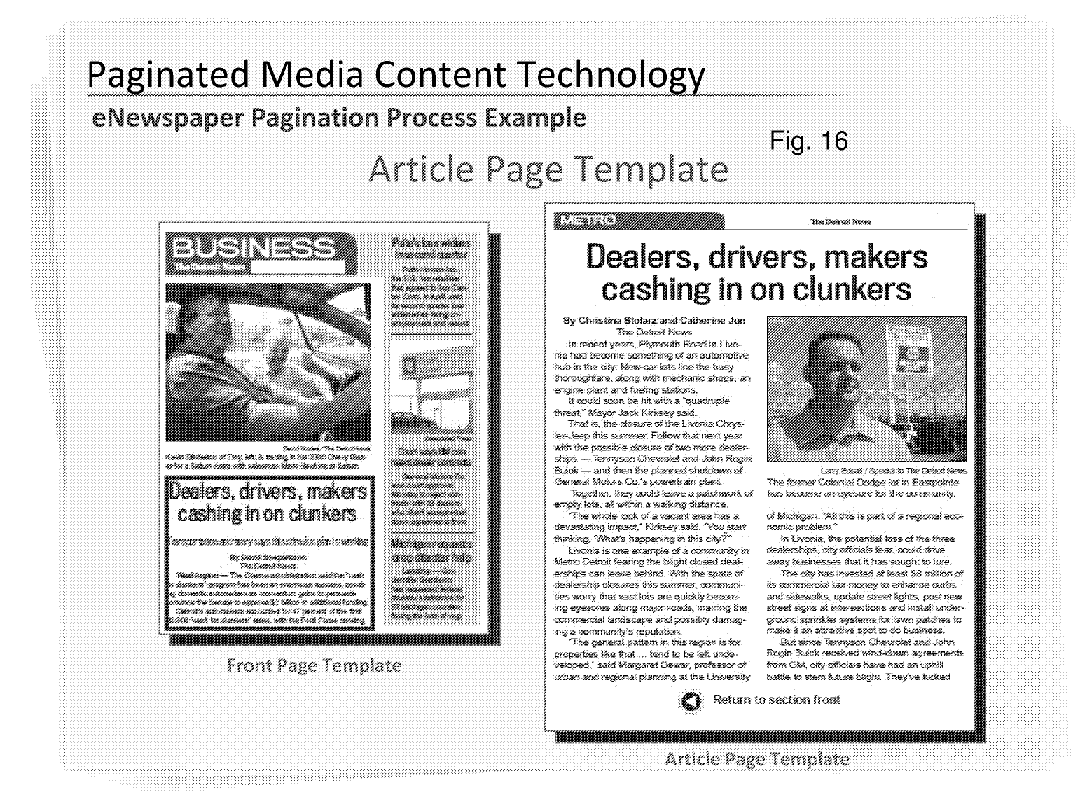

In FIG. 16 the front business page template of FIGS. 14 and 15 is shown next to an article page template.

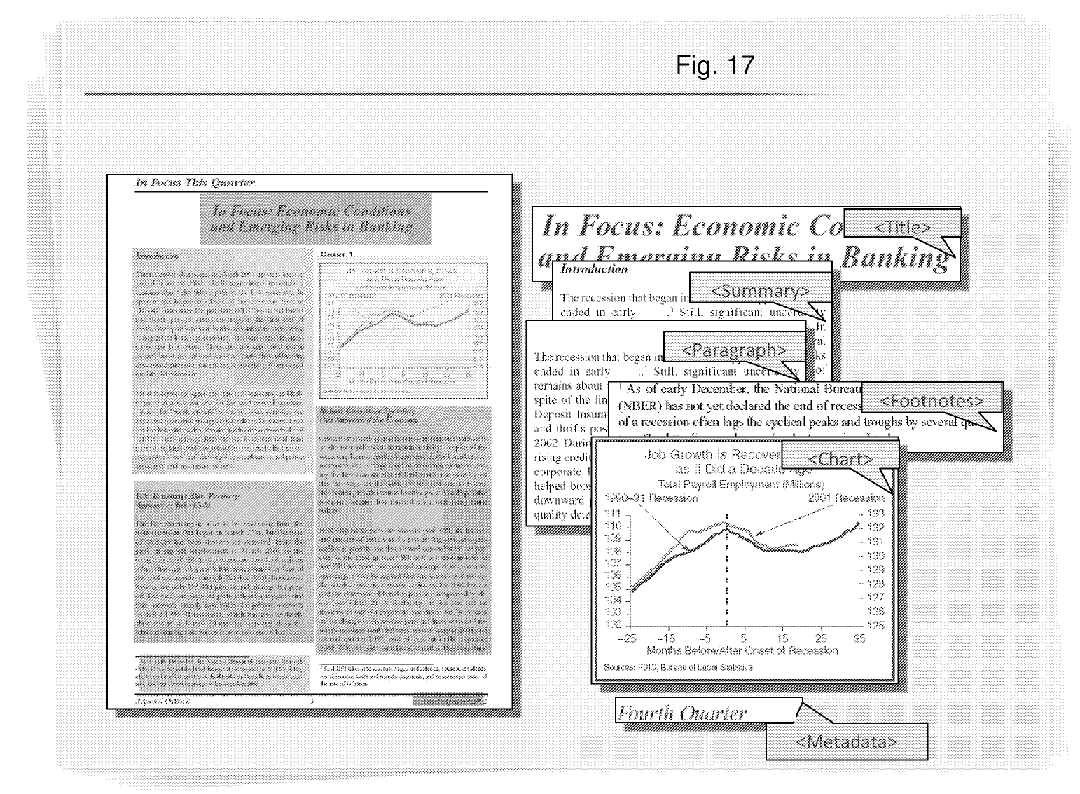

FIG. 17 illustrates features of the XML distiller of FIG. 9. The XML distiller uses a priori knowledge of a type of publication, in order to find and tag different types of data. In the example, headlines, summary, graph, text paragraphs, and metadata are all identified and tagged, for use as input to the multi-channel publisher of the present embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A computerized multi-channel publishing system for electronic publishing of tagged content in a plurality of output versions via a plurality of channels, the system comprising:
an input for receiving said tagged content;
a plurality of intelligent layout rule receptacles, each receptacle comprising embedded cells associated with tags, the cells for accommodating said tagged content, said cells able to carry out said accommodating of tagged content according to predetermined rules selected for a respective output version, thereby to provide receptacles each modified for a respective output version;
a tagged content insertion unit operative for inserting said tagged content into each of said receptacles, in each receptacle said cells adjusting themselves according to said predetermined rules to allow fitting of said content in each receptacle, thereby to form said plurality of versions of said tagged content optimized for said respective output version; and
a publishing unit for outputting said plurality of versions.

2. The system of claim 1, wherein each output version has a condition for readability and said predetermined rules comprise layout conditions to fulfill said readability condition.

3. The system of claim 2, wherein each output version is associated with an output device having a screen of a given size and wherein said layout conditions comprise a minimum text size on said screen.

4. The system of claim 2, wherein each output version is associated with an output device having a screen of a given shape and wherein said layout conditions comprise filling of said given shape.

5. The system of claim 1, wherein said accommodation comprises cells adjusting their sizes according to respective tagged content set therein.

6. The system of claim 1, comprising a rule derivation unit for accepting as input user templates dedicated to each of said versions and deriving said rules from said templates.

7. The system of claim 1, wherein one of said predetermined rules is applied to all of said versions.

8. The system of claim 1, comprising providing a plurality of receptacles for different parts of a same version.

9. The system of claim 1, wherein respective receptacles comprise cells for text and cells for images.

10. The system of claim 9, wherein said cells for text are arranged as columns and respective ones of said predetermined rules allow one of said cells for images to extend over variable numbers of said columns.

11. The system of claim 9, wherein said cells for images comprise functionality to resize images inserted therein in accordance with corresponding ones of said predetermined rules.

12. A computerized multi-channel publishing method for electronic publishing of tagged content in a plurality of output versions via a plurality of channels, the method comprising:
receiving said tagged content;
providing a plurality of intelligent layout rule receptacles, each receptacle comprising embedded cells associated with tags, the cells for accommodating said tagged content, said cells able to carry out said accommodating of tagged content according to predetermined rules selected for a respective output version, thereby to provide receptacles each modified for a respective output version;
inserting said tagged content into each of said receptacles, in each receptacle said cells adjusting themselves according to said predetermined rules to allow fitting of said content in each receptacle, thereby to form said plurality of versions of said tagged content optimized for said respective output version; and
outputting said plurality of versions.

13. The method of claim 12, wherein each output version has a condition for readability and said predetermined rules comprise layout conditions to fulfill said readability condition.

14. The method of claim 13, wherein each output version is associated with an output device having a screen of a given size and wherein said layout conditions comprise a minimum text size on said screen.

15. The method of claim 13, wherein each output version is associated with an output device having a screen of a given shape and wherein said layout conditions comprise filling of said given shape.

16. The method of claim 12, wherein said accommodation comprises cells adjusting their sizes according to respective tagged content set therein.

17. The method of claim 12, comprising accepting as input user templates dedicated to each of said versions and deriving said rules from said templates.

18. The method of claim 12, wherein one of said predetermined rules is applied to all of said versions.

19. The method of claim 12, comprising providing a plurality of receptacles for different parts of a same version.

20. The method of claim 12, wherein respective receptacles comprise cells for text and cells for images.

21. The method of claim 20, wherein said cells for text are arranged as columns and respective ones of said predetermined rules allow one of said cells for images to extend over variable numbers of said columns.

22. The method of claim 20, comprising enabling said cells for images to resize images inserted therein in accordance with corresponding ones of said predetermined rules.
